(19) United States
(12) Patent Application Publication
(10) Pub. No.: US 2005/0029047 A1
(43) Pub. Date: Feb. 10, 2005

(54) Ladder sculptures and method of use

(76) Inventor: Richard Jennings MacConnell JR., Boca Raton, FL (US)

Correspondence Address: CLARK & BRODY, 1750 K STREET NW, SUITE 600, WASHINGTON, DC, 20006, US

(21) Appl. No.: 10/879,285

(22) Filed: Jun. 30, 2004

Related U.S. Application Data
(60) Provisional application No. 60/483,922, filed on Jul. 2, 2003.

(51) Int. Cl. E06C 1/00; E04G 1/00; E04G 3/00; E06C 5/32

(52) U.S. Cl. 182/129

(57) ABSTRACT

The present invention is directed to ladder sculptures and methods of use, and in particular to anthropomorphized ladder sculptures. The ladder structure has a first ladder leg with a portion having a shape generally depicting a profile of a human male or human female body an a second ladder leg with a portion having a shape of a human male or human female body. A plurality of rungs interconnect the first and second ladder legs, with the portions depicting the human female or male body shape positioned between top and bottom ends of the ladder legs.

This application claims priority under 35 USC 119(e) based on application Ser. No. 60/483,922 filed on Jul. 2, 2003, and herein incorporated in its entirety by reference.

### FIELD OF THE INVENTION

The present invention is directed to ladder sculptures and methods of use, and in particular to anthropomorphized ladder sculptures.

### BACKGROUND ART

In the prior art, the use of ladders in other applications is known. U.S. Pat. No. D31,418 to Wilson discloses a game frame in the shape of side-by-side ladders.

It is also known to incorporate living images with a ladder. U.S. Pat. No. D78,040 to Muller shows a step ladder that includes images of a bunny rabbit on its side legs.

U.S. Pat. No. D89,409 to Porter discloses a table that has animate figures for its legs.

### SUMMARY OF THE INVENTION

A first object of the invention is to provide a new type of ladder sculpture.

Another object of the invention is a ladder sculpture that is anthropomorphized in that it has ladder legs with human body profiles/shapes.

A further object of the invention is a method of using the ladder sculptures to portray human images/shapes on a wall or other surface.

One other object is the use of the ladder sculpture as a support for another structure such as a table top, ash tray, flower pot, a shelf or shelves, or the like.

Other objects and advantages will become apparent when reviewing the description below.

The ladder sculpture of the invention comprises a first ladder leg with a portion having a shape generally depicting a profile of a human male or human female body and a second ladder leg with a portion having a shape of a human male or human female body. A plurality of rungs are provided that interconnect the first and second ladder legs. Portions of the ladder legs having the human female or male body shape are positioned between top and bottom ends of the ladder legs.

In one embodiment, the first leg can have a human male body profile and the second leg can have a human female body profile. Alternatively, the first and second legs can be both human male or female body profiles.

The top end of the ladder legs can be shaped like a human hand, and/or the bottom end of the ladder legs can take on the form of a human foot.

The bottom ends of the ladder legs can be interconnected by a base. Similarly, the top ends of the ladder legs can support an article, whereby the article is further adapted to support or display other items, or be used for display purposes itself. In a preferred embodiment, the ladder top ends include hands, with the hands configured so to support the article.

The invention also includes a method of use of the ladder sculptures. In this method, a light source is provided and directed against one or more sculptures, that are positioned adjacent a wall surface. The ladder sculptures create shadows on the wall surface, creating an image of human forms. Any of the above-described ladder sculptures can be utilized in the image creating method.

### BRIEF DESCRIPTION OF THE DRAWINGS

FIG. 1 is a perspective view of one embodiment of the invention;

FIG. 2 is a perspective view of another embodiment of the invention;

FIG. 3 is an exploded view of the embodiment of FIG. 1; and

FIG. 4 is a partial view of a third embodiment of the invention.

### DESCRIPTION OF THE PREFERRED EMBODIMENTS

The present invention offers a unique form of sculpture using ladders whereby the ladders are anthropomorphized with ladder legs having human body profiles or shapes. The ladder sculpture can be used for decorative purposes, or in conjunction with another member or article in a support or display mode.

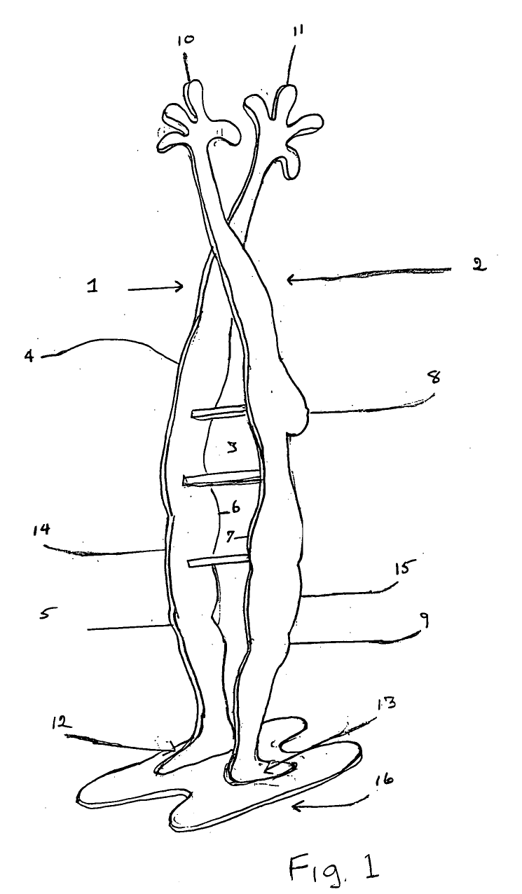

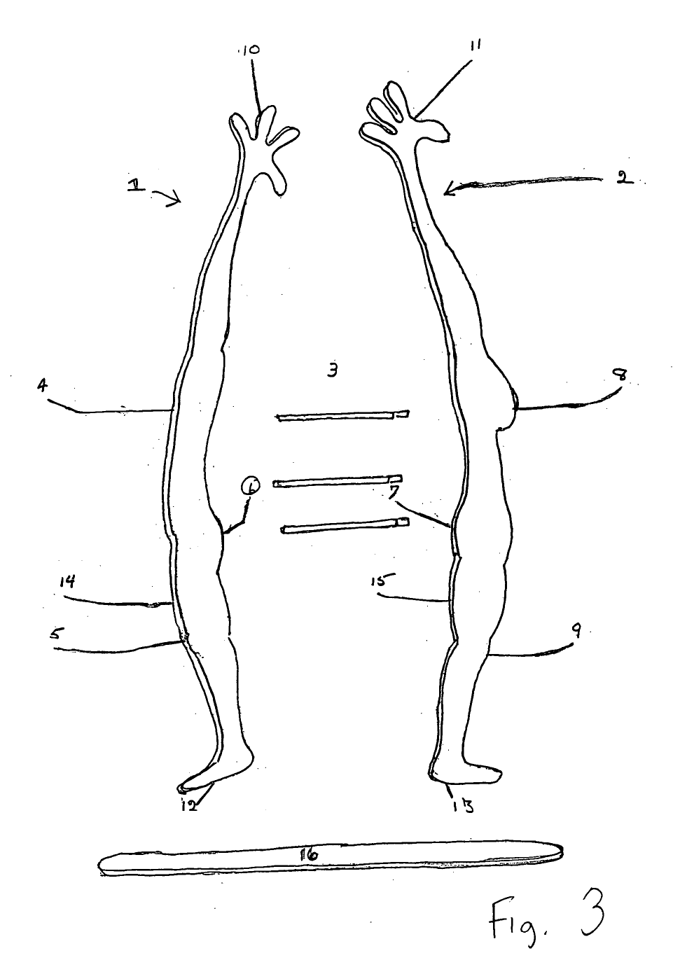

FIGS. 1 and 3 show a first embodiment of the invention wherein the ladder sculpture is designated by the reference numeral 10. The ladder sculpture has a pair of legs 1 and 2, and rungs 3 interconnecting the legs/sides.

Leg 1 has a middle section that has the profile of a human male, with leg 2 having its middle section shaped with the profile of a human female. The edges of the legs 1 and 2 are made to represent various features of a human body. For example, in leg 1, a chest is found at 4, a knee at 5, buttocks at 6, etc. Similar features are shown represented on leg 2, buttocks at 7, breast at 8, knee at 9. The depicted profiles of the human male and females are exemplary, and other shapes could be used. For example, the body profile could be made larger or smaller to represent thin or overweight bodies. Alternatively, certain features could be exaggerated, such as the male's chest to represent strength.

In the FIG. 1 embodiment, top ends 10 and 11 of the ladder legs are shaped to resemble human hands. Bottom ends 12 and 13 depict human feet. Bottom ends 12 and 13 rest on a base 14. The base 14 is shown with an oval shape, but it can have any shape desired. The base, besides having a decorative aspect, also allows the ladder legs 1 and 2 to stay free standing. Of course, the legs could be used without the base and/or hands at the ladder leg top ends if so desired.

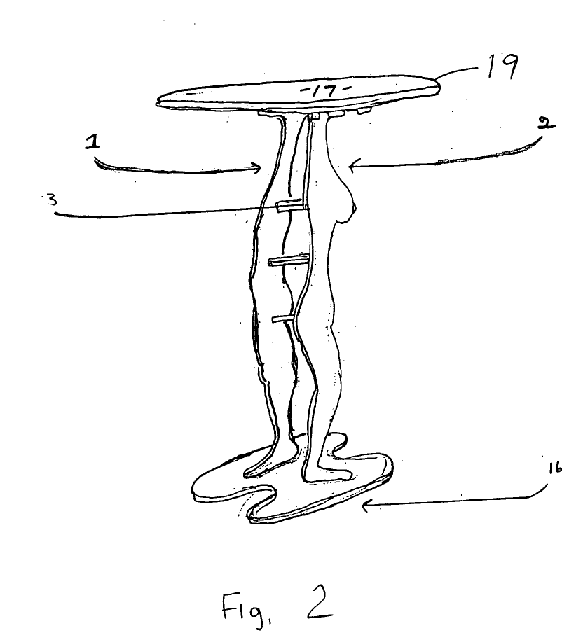

FIG. 2 shows another embodiment of the ladder sculpture of the invention. This embodiment employs an additional structure in the form of a member or article positioned at or near the top ends of the ladder legs. In this embodiment, the ladder legs 1 and 2 again represent male and female forms, with rungs 3 interconnecting the legs 1 and 2. A base 16 is included for stability. A table top 16 is shown being supported by the legs 1 and 2, with the table top 16 providing a surface 17 for virtually any use.

While a table top 16 is shown, the ladder top ends could be used to support virtually any article that would provide an additional utility to the sculpture, e.g., an ash tray, a flower pot, champagne bucket, multiple shelves, an easel, a towel rack, lamp, etc. These articles would be attached to the top ends using conventional technology. In yet another mode, although not shown, the hands of the FIG. 1 embodiment could be depicted as holding the table top or some other article such as a flower pot, etc. In this mode, the shape given to the ladder leg top ends would be visible in conjunction with the added member or article. While the article being supported by the ladder top ends can be used to support or display another item, the article itself could be used for displaying, e.g., a world globe or the like.

While FIGS. 1-3 show a base, the ladder bottom ends could be shaped so that the leg ends themselves could provide the needed stability to allow the sculpture to rest with leaning against a surface. For example, the width of the legs could. be enlarged at the bottom end, or gussets or other supports could be attached to each leg end for support purposes.

In an exemplary use of the ladder sculptures, a pair of sculptures can be employed, each having hands 10 and 11 at top ends thereof, feet and a sculpture base at the bottom ends, see FIG. 1. Light is shone at the sculptures, thus producing shadow imagery on surface located behind the sculptures, the sculptures located between the light source and surface. Because of the profiles of the ladder legs, the imagery on the surface is also representative of the human form.

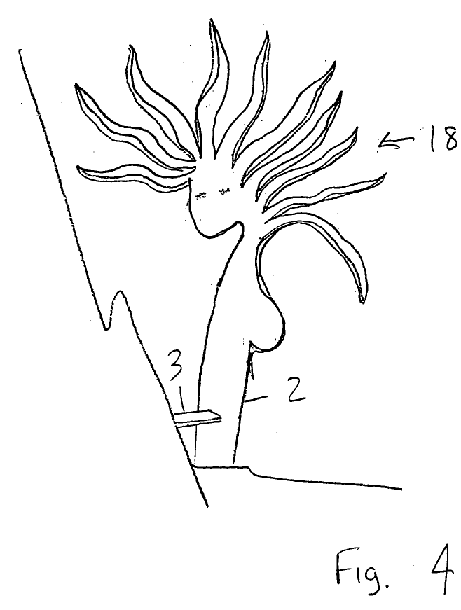

FIG. 4 shows a part of a ladder sculpture wherein a top end of the ladder leg 2 is in the shape of a human female head 18, with a face and hair.

It should also be understood that the embodiment of FIG. 1 is one version of the invention, but the invention is not so limited. For example, the body profiles could terminate in other shapes than hands and feet, such as a head shape for the top end. Likewise, the bottom ends could be made with other parts symbolizing human anatomy.

The sculptures can be made of any material, e.g., metal, wood, plastics, composites or combinations thereof. The attachment between the rungs and legs, and base and legs can also take any form, such as welding if the pieces are metal, or through the use of fasteners, adhesives or combinations thereof.

As such, an invention has been disclosed in terms of preferred embodiments thereof which fulfills each and every one of the objects of the present invention as set forth above and provides a ladder sculpture which is adapted for display purposes, and as a support for other articles or members.

Of course, various changes, modifications and alterations from the teachings of the present invention may be contemplated by those skilled in the art without departing from the intended spirit and scope thereof. It is intended that the present invention only be limited by the terms of the appended claims.

1. A ladder sculpture comprising:
a) a first ladder leg with a portion having a shape generally depicting a profile of a human male or human female body;
b) a second ladder leg with a portion having a shape of a human male or human female body; and
c) a plurality of rungs interconnecting the first and second ladder legs;
d) wherein portions having the human female or male body shape are between top and bottom ends of the ladder legs.

2. The ladder sculpture of claim 1, wherein the first leg has a human male body profile and the second leg has a human female body profile, or the first and second legs are both human male or female body profiles.

3. The ladder sculpture of claim 1, wherein a top end of either of both of the ladder legs is shaped like a human hand.

4. The ladder sculpture of claim 2, wherein a top end of either of both of the ladder legs is shaped like a human hand.

5. The ladder sculpture of claim 1, wherein a bottom end of either of both of the ladder legs is shaped like a human foot.

6. The ladder sculpture of claim 2, wherein a bottom end of either of both of the ladder legs is shaped like a human foot.

7. The ladder sculpture of claim 3, wherein a bottom end of either of both of the ladder legs is shaped like a human foot.

8. The ladder sculpture of claim 1, wherein the bottom end is connected together by a base.

9. The ladder sculpture of claim 2, wherein the bottom end is connected together by a base.

10. The ladder sculpture of claim 3, wherein the bottom end is connected together by a base.

11. The ladder sculpture of claim 4, wherein the bottom end is connected together by a base.

12. The ladder sculpture of claim 1, wherein ladder sculpture includes an article supported by the ladder legs, the article being adapted to support or display one or more items, or being adapted for display.

13. The ladder sculpture of claim 2, wherein ladder sculpture includes an article supported by the ladder legs, the article adapted to support or display one or more items, or being adapted for display.

14. The ladder sculpture of claim 3, wherein ladder sculpture includes an article supported by the ladder legs, the article adapted to support or display one or more items, or being adapted for display.

15. The ladder sculpture of claim 4, wherein ladder sculpture includes an article supported by the ladder legs, the article adapted to support or display one or more items, or being adapted for display.

16. The ladder sculpture of claim 5, wherein ladder sculpture includes an article supported by the ladder legs, the article adapted to support or display one or more items.

17. The ladder sculpture of claim 3, wherein each ladder top end is formed with a hand, and the ladder sculpture includes an article supported at least in part by the hands, the article adapted to support or display one or more items.

18. A method of displaying a human form on a surface comprising the steps of:
a) providing the ladder sculpture comprising
i) a first ladder leg with a portion having a shape generally depicting a profile of a human male or human female body;
ii) a second ladder leg with a portion having a shape of a human male or human female body; and
iii) a plurality of rungs interconnecting the first and second ladder legs;
iv) wherein portions having the human female or male body shape are between top and bottom ends of the ladder legs; and
b) shining light past the ladder sculpture to portray an image of a human body on a surface receiving the light.

19. The ladder sculpture of claim 1, wherein the first leg has a human male body profile and the second leg has a human female body profile, or the first and second legs are both human male or female body profiles.
